(19) United States
(12) Patent Application Publication
(10) Pub. No.: US 2008/0117131 A1
(43) Pub. Date: May 22, 2008

(54) PLASMA DISPLAY DEVICE

(76) Inventors: Hakki Choi, Yongin-si (KR); Sungsu Lee, Yongin-si (KR)

Correspondence Address: CHRISTIE, PARKER & HALE, LLP, PO BOX 7068, PASADENA, CA, 91109-7068, US

(21) Appl. No.: 11/941,810

(22) Filed: Nov. 16, 2007

(30) Foreign Application Priority Data
Nov. 21, 2006 (KR) 10-2006-0115244

(51) Int. Cl. G09G 3/28

(52) U.S. Cl. 345/60

(57) ABSTRACT

A plasma display device including a plasma display panel having a plurality of first electrodes and a plurality of second electrodes, a first electrode driver for driving the plurality of first electrodes, the first electrode driver including a first energy recovery circuit having a first resonance coil, and a second electrode driver for driving the plurality of second electrodes, the second electrode driver including a second energy recovery circuit having a second resonance coil. The first resonance coil has a first inductance that is different from a second inductance of the second resonance coil.

### CROSS-REFERENCE TO RELATED APPLICATIONS

This application claims priority to and the benefit of Korean Patent Application No. 10-2006-0115244, filed on Nov. 21, 2006 in the Korean Intellectual Property Office, the entire content of which is incorporated herein by reference.

### BACKGROUND OF THE INVENTION

1. Field of the Invention

The present invention relates to a plasma display device, and in particular, relates to a driving method of a plasma display device.

2. Description of the Related Art

A plasma display device is a flat panel display device including a plasma display panel which includes a plurality of electrodes on each of two opposing substrates, wherein a discharging gas is injected and sealed into a plurality of discharge cells between the two opposing substrates. The plasma display device is thinner as compared with a cathode ray tube (CRT) display device occupying a large volume, and thus, the plasma display device is very suitable for realizing a light-weight and large screen in a small volume. As compared with other flat panel displays such as liquid crystal display (LCD), the plasma display device requires no active element such as transistor on the substrates, and has a wide viewing angle and a high brightness.

The plasma display device realizes a gray scale required for displaying an image by adjusting the number of times of cell discharging within a frame. The gray scale is displayed by an Address and Display Period Separated (ADS) driving method. In the ADS driving method, driving is performed by dividing the frame into a plurality of sub-fields, each of which has a different number of times of discharging. Each of the sub-fields includes a reset period for generating a uniform discharging, an address period for selecting discharging cells, and a sustain period for displaying the gray scale according to the number of times of discharging.

The plasma display device includes an X electrode driver and a Y electrode driver including respective sustain pulse driving circuits for providing respective sustain pulses to X electrodes and Y electrodes, so that discharging of the selected discharging cells can be maintained during the sustain period. A panel capacitor is formed by a crossing between the X electrode and the Y electrode of the plasma display panel.

The X electrode driver and the Y electrode driver respectively include energy recovery circuits for recovering the energy generated by the plasma display device and for enhancing the energy consumption effectiveness of the plasma display device by supplying the recovered energy to the plasma display panel. Each of the energy recovery circuits includes an energy storage unit for storing the energy, an energy controller including a supply switch and a recovery switch for supplying and recovering the energy, and a resonance coil.

The sustain pulse alternates between a first voltage and a ground voltage lower than the first voltage. The sustain pulse can be divided into a first step in which the sustain pulse rises from the ground voltage to the first voltage, a second step in which the sustain pulse is maintained at the first voltage, a third step in which the sustain pulse falls from the first voltage to the ground voltage, and a fourth step in which the sustain pulse is maintained at the ground voltage.

During the first step, the energy recovery circuit is operated to provide the energy stored in the energy storage unit to the plasma display panel through an LC resonance generated by using the resonance coil and the panel capacitor.

During the second step, the supply switch coupled to a first power supply for providing the first voltage is operated to maintain the first voltage.

During the third step, the recovery switch of the energy recovery circuit is operated to recover the energy charged in the plasma display panel due to the LC resonance, generated by using the resonance coil and the panel capacitor, to the energy storage unit of the energy recovery circuit.

During the fourth step, a ground switch coupled to a ground for providing the ground voltage is operated to maintain the ground voltage.

In more detail, a rising edge time of the sustain pulse during the first step and a falling edge time of the sustain pulse during the third step are affected by respective parasitic capacitances of respective circuit elements of the X electrode driver and the Y electrode driver, and a parasitic capacitance along the current path.

FIG. 1 illustrates a schematic diagram of sustain pulses applied to electrodes of a conventional plasma display device.

Referring to FIG. 1, a voltage rising edge a1 and a voltage falling edge c1 of the sustain pulse applied to a Y electrode are relatively slower respectively than a voltage rising edge a2 and a voltage falling edge c2 applied to an X electrode. Therefore, a maintaining period b1 of the sustain pulse applied to the Y electrode is relatively shorter than a maintaining period b2 of the sustain pulse applied to the X electrode (i.e., I1<I2, wherein I1 and I2 are time durations).

Since the Y electrode driver of the plasma display device includes relatively more pulse driving circuits as compared with that of the X electrode driver, the Y electrode driver has a more complicated structure. The Y electrode driver includes more switching elements; therefore, a voltage pulse generated by the Y electrode driver involves a longer current path as compared with that of the X electrode driver. Thus, the Y electrode driver has more parasitic components than the X electrode driver. The parasitic components decrease the effectiveness of the LC resonance generated by using the resonance coil and the panel capacitor, and reduce the slop of the resonance response. The slops of the voltage pulse rising edge and the voltage pulse falling edge are decreased in proportion to the slop of the resonance response. However, in the conventional plasma display device, the inductances of the resonance coils included in the X electrode driver and the Y electrode driver respectively are the same. Therefore, the sustain pulses applied to the X electrode and the Y electrode respectively have different voltage rising edges and different voltage falling edges due to the differences of the respective parasitic capacitances of the X electrode driver and the Y electrode driver. When the sustain pulses described above are respectively applied to the X electrode and the Y electrode, there is a difference between a discharging start timing and a discharging maintaining timing for each of the discharging cells of the plasma display device. Thus, a discharge smear can occur.

### SUMMARY OF THE INVENTION

An aspect of an exemplary embodiment according to the present invention is to provide a plasma display device in which a first resonance coil and a second resonance coil respectively included in a first electrode driver and a second electrode driver, which are coupled to a plurality of first electrodes and second electrodes, have different inductances, thereby a discharging smear is eliminated or reduced during a sustain period.

In one embodiment, a plasma display device according to the present invention includes a plasma display panel having a plurality of first electrodes and a plurality of second electrodes, a first electrode driver for driving the plurality of first electrodes, the first electrode driver including a first energy recovery circuit having a first resonance coil, and a second electrode driver for driving the plurality of second electrodes, the second electrode driver including a second energy recovery circuit having a second resonance coil. The first resonance coil has a first inductance that is different from a second inductance of the second resonance coil.

The first electrode driver and the second electrode driver each can include a sustain pulse driving circuit for applying a sustain pulse to the first electrodes and the second electrodes during a sustain period, respectively. The sustain pulse driving circuit can include a first voltage driving circuit for applying a first voltage and a ground voltage driving circuit for applying ground. The first voltage supply circuit can be coupled to a first power supply and include a first voltage switch having a first voltage terminal coupled to the first power supply. The ground voltage supply circuit can be coupled to ground and include a ground voltage switch having a first ground terminal coupled to ground. A second terminal of the first voltage switch and a second terminal of the ground voltage switch can be electrically coupled to the first electrodes and the second electrodes, respectively.

The first electrode driver can further include a reset rising pulse supply circuit for applying a second voltage to the first electrodes by increasing a voltage applied to the first electrodes from the first voltage gradually during a reset rising period, a reset falling pulse supply circuit for applying a third voltage to the first electrodes by reducing the voltage applied to the first electrodes from the first voltage gradually during a reset falling period. The first electrode driver can also include a scanning switch circuit including a first scanning switch and a second scanning switch, the first scanning switch and the second scanning switch are coupled to the first electrodes, and a scan low pulse supply circuit and a scan high pulse supply circuit for applying a fourth voltage and a fifth voltage to the first electrodes in response to the operations of the scanning switch circuit during an address period.

The first electrode driver can further include a short prevention switch coupled between the sustain pulse driving circuit and the reset falling pulse supply circuit.

The second electrode driver can further include a bias voltage supply circuit for applying a bias voltage higher than an address voltage to the second electrodes during the reset falling period and the address period.

The short prevention switch and the second scanning switch can be coupled between the first resonance coil and a panel capacitor formed between a corresponding one of the first electrodes and a corresponding one of the second electrodes.

The short prevention switch and the second scanning switch can be Metal Oxide Semiconductor Field Effect Transistor (MOSFET) type switches.

A first current path of the first electrode driver for applying a first sustain pulse to the first electrodes can be longer than a second current path of the second electrode driver for applying a second sustain pulse to the second electrodes.

The first inductance of the first resonance coil according to the present invention can be selected to be smaller than the second inductance of the second resonance coil.

The inductance of the first resonance coil can be substantially between 0.1 μH and 0.2 μH, and the inductance of the second resonance coil can be substantially between 0.2 μH and 0.3 μH.

The first energy recovery circuit and the second energy recovery circuit can include a first supplying switch and a first recovery switch, and a second supplying switch and a second recovery switch, respectively, for supplying and recovery energy to and from the plasma display panel. A first terminal of the first resonance coil and a first terminal of the second resonance coil are electrically coupled to the first electrodes and the second electrodes, respectively. A second terminal of the first resonance coil is coupled to a source terminal of the first supply switch and a drain terminal of the first recovery switch. A second terminal of the second resonance coil is coupled to a source terminal of the second supplying switch and a drain terminal of the second recovery switch. The first energy recovery circuit and the second energy recovery circuit may include a first energy charging/discharging capacitor and a second energy charging/discharging capacitor, respectively. The first energy charging/discharging capacitor is coupled between ground and a first node that is coupled to a drain terminal of the first supplying switch and a source terminal of the first recovery switch. The second energy charging/discharging capacitor is coupled between ground and a second node that is coupled to a drain terminal of the second supplying switch and a source terminal of the second recovery switch.

In another embodiment, a plasma display device includes a plasma display panel having a plurality of first electrodes and a plurality of second electrodes, a first electrode driver for applying a first sustain pulse to the first plurality of electrodes; and a second electrode driver for applying a second sustain pulse to the plurality of second electrodes, the first sustain pulse and the second sustain pulse are alternately applied. The first electrode driver and the second electrode driver are configured to generate the first and the second sustain pulses that have at least one of substantially same rising slopes or substantially same falling slopes. The first electrode driver may include a first energy recovery circuit having a first resonance coil, and the second electrode driver may include a second energy recovery circuit having a second resonance coil, the first resonance coil having a first inductance that is difference from a second inductance of the second coil. The first electrode driver may apply the first sustain pulse through a first current path, and the second electrode driver may apply the second sustain pulse through a second current path, the first current path being longer than the second current path.

### BRIEF DESCRIPTION OF THE DRAWINGS

The above and other aspects and features of the present invention will be more apparent from the following detailed description taken in conjunction with the accompanying drawings, in which:

FIG. 1 illustrates a schematic diagram of sustain pulses applied to electrodes of a conventional plasma display device.

FIG. 2 illustrates a diagram of a plasma display device according to an exemplary embodiment of the present invention.

FIG. 3 illustrates a schematic diagram of driving circuits of a plasma display device according to an exemplary embodiment of the present invention.

FIG. 4a illustrates an operation timing diagram of the sustain pulses applied by the driving circuits illustrated in FIG. 3.

FIG. 4b illustrates an enlarged diagram of the sustain pulses of FIG. 4a.

FIGS. 5a-5f illustrate current paths corresponding to respective steps of the operation timing diagram illustrated in FIG. 4a.

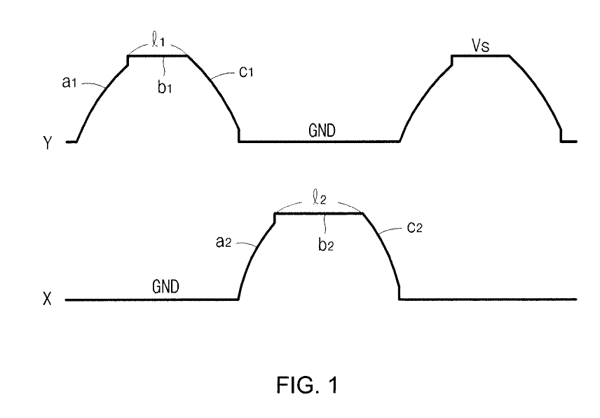

### DETAILED DESCRIPTION OF THE EMBODIMENTS

Exemplary embodiments of the present invention will be explained in detail with reference to the accompanying drawings. Some of the elements which are not essential to a complete understanding of the invention are omitted for clarity. Also, like reference numerals refer to like elements throughout the specification.

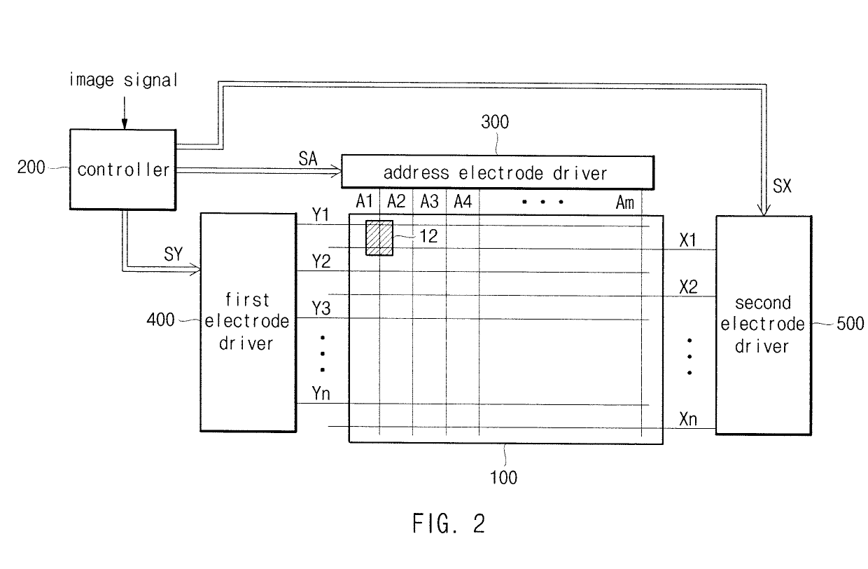

FIG. 2 illustrates a diagram of a plasma display device according to an exemplary embodiment of the present invention.

Referring to FIG. 2, a plasma display device according to an exemplary embodiment of the present invention includes a plasma display panel (PDP) 100, a controller 200, an address electrode driver 300, a first electrode driver 400, and a second electrode driver 500.

The PDP 100 includes a plurality of address electrodes A1, A2, . . . , Am each extending in a row direction; and a plurality of first electrodes Y1, Y2, . . . , Yn and a plurality of second electrodes X1, X2, . . . , Xn alternately arranged and each extending in a column direction. A plurality of discharge cells 12 are formed for realizing a plurality of unit pixels of the PDP 100 at the respective points where the first electrodes and the second electrodes cross with the address electrodes.

The controller 200 receives an image signal from an outside source and creates an address control signal SA for controlling the address electrodes A1, A2, . . . , Am; a first control signal SY for controlling the first electrodes Y1, Y2, . . . , Yn; and a second control signal SX for controlling the second electrodes X1, X2, . . . , Xn. The address control signal SA, the first control signal SY, and the second control signal SX are respectively transmitted to the address electrode driver 300, the first electrode driver 400, and the second electrode driver 500. Also, the controller 200 divides one frame into a plurality of sub-fields each of which has its own weight and drives each sub-field by dividing each sub-field into a reset period, an address period, and a sustain period.

The address electrode driver 300, which includes a plurality of address driving circuits, receives the address control signal SA from the controller 200 and applies a plurality of driving pulses to the respective address electrodes A1, A2, . . . , Am.

The first electrode driver 400 includes one or more first electrode driving circuits which receive the first control signal SY from the controller 200 and apply a plurality of driving pulses to the first electrodes Y1, Y2, . . . , Yn.

The second electrode driver 500 includes one or more second electrode driving circuits which receive the second control signal SX from the controller 200 and apply a plurality of driving pulses to the second electrodes X1, X2, . . . , Xn.

Exemplary driving circuits of the plasma display device according to an exemplary embodiment of the present invention will be explained. When an element A is described as being coupled to an element B, the element A can be directly or indirectly electrically connected to the element B. An exemplary first driving circuit of the first electrode driver 400 and an exemplary second driving circuit of the second electrode driver 500 will be used to illustrate the exemplary embodiment. Hereinafter, a “Y electrode” is one of the first electrodes Y1, Y2, . . . , Yn, and an “X electrode” is one of the second electrodes X1, X2, . . . , Xn.

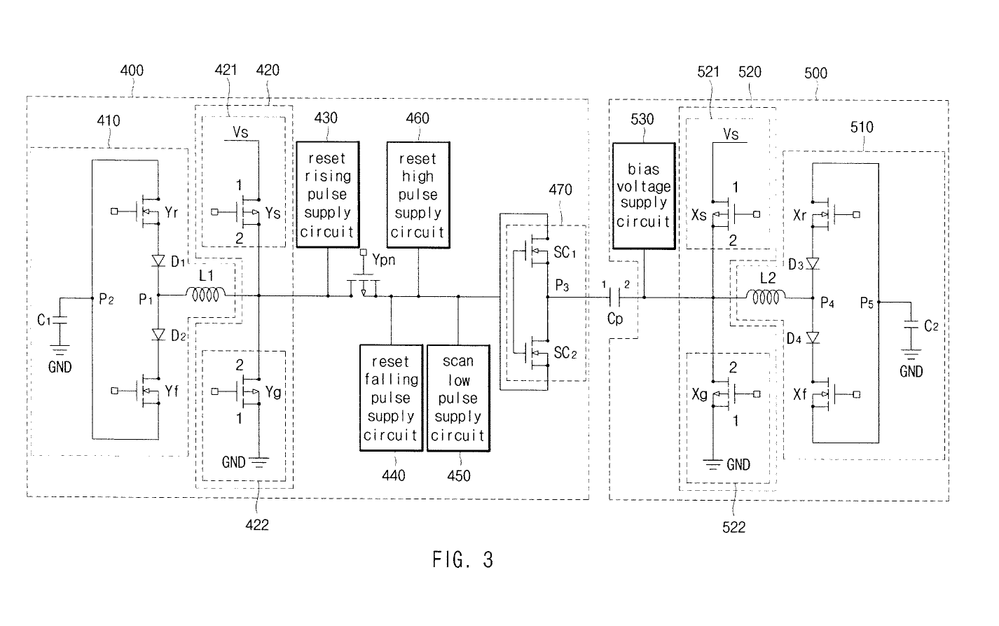

FIG. 3 illustrates a diagram of a first driving circuit of the first electrode driver 400 and a second driving circuit of the second electrode driver 500 included in a plasma display device according to an exemplary embodiment of the present invention.

In FIG. 3, switching transistors are shown as N-channel field effect transistors (FETs), each including a body diode (not shown). However, the switching transistors can be replaced with other elements providing same or similar functions, and the present invention is not limited to the exemplary embodiment.

Referring to FIG. 3, the plasma display device includes the first electrode driver 400 for driving the Y electrodes, the second electrode driver 500 for driving the X electrodes, and a panel capacitor Cp formed by a Y electrode and a corresponding X electrode, wherein the Y electrode is coupled to a first terminal of the panel capacitor Cp, and the X electrode is coupled to a second terminal of the panel capacitor Cp. The Y electrode driver 400 includes a first energy recovery circuit 410, and the X electrode driver 500 includes a second energy recovery circuit 510. The first energy recovery circuit 410 and the second energy recovery circuit 510 respectively include a first resonance coil L1 and a second resonance coil L2. LC resonances can be generated between the panel capacitor Cp and the first resonance coil L1, and between the panel capacitor Cp and the second resonance coil L2. In one embodiment, the first resonance coil L1 and the second resonance coil L2 have different inductances.

The first electrode driver 400 includes the first energy recovery circuit 410, a first sustain pulse driving circuit 420, a reset rising pulse supply circuit 430, a reset falling pulse supply circuit 440, a scan low pulse supply circuit 450, a scan high pulse supply circuit 460, and a scanning switch circuit 470.

The first energy recovery circuit 410 includes a first supply switch Yr and a first recovery switch Yf for controlling supply/recovery of the energy to/from the plasma display panel respectively, a first energy charging/discharging capacitor C1, and a first resonance coil L1 for storing the energy provided to and recovered from the PDP. A first terminal of the first resonance coil L1 is coupled to the Y electrode (i.e., the first terminal of Cp), and a second terminal of the first resonance coil L1 is coupled to a node P1 at which a source terminal of the first supply switch Yr and a drain terminal of the first recovery switch Yf are coupled together. The first charging/discharging capacitor C1 is coupled between a ground GND and a node P2 at which a drain terminal of the first supply switch Yr and a source terminal of the first recovery switch Yf are coupled together. The first energy recovery circuit 410 further includes a first diode D1 having an anode coupled to the first supply switch Yr and a cathode coupled to the first resonance coil L1, and a second diode D2 having an anode coupled to the first resonance coil L1 and a cathode coupled to the first recovery switch Yf.

When the LC resonance is generated by using the first resonance coil L1 and the panel capacitor Cp, a resonance current flows into the first resonance coil L1, and thereby the energy is provided/recovered to/from the panel capacitor Cp during the sustain period. The first resonance coil L1 is set to a suitable inductance value necessary for generating the LC resonance based on the capacitance of the panel capacitor Cp. In one embodiment, the inductance of the first resonance coil L1 is determined based on a parasitic inductance, a parasitic capacitance, and a parasitic resistance of the corresponding driving circuit current path.

The first sustain pulse driving circuit 420 applies sustain pulses to the Y electrode (i.e., the first terminal of Cp) during the sustain period. The first sustain pulse driving circuit 420 includes a Y electrode first voltage driving circuit 421 and a Y electrode ground voltage driving circuit 422 for applying the first voltage and the ground voltage to the Y electrode (i.e., the first terminal of Cp) alternately. The Y electrode first voltage driving circuit 421 includes a first power source Vs and a Y electrode first voltage switch Ys having a first terminal coupled to the first power source Vs and a second terminal coupled to the Y electrode (i.e., the first terminal of Cp). The Y electrode ground voltage driving circuit 422 includes a ground GND and a first ground voltage switch Yg having a first terminal coupled to the ground voltage and a second terminal coupled to the Y electrode (i.e., the first terminal of Cp). The second terminal of the Y electrode first voltage switch Ys and the second terminal of the first ground voltage switch Yg are coupled to the Y electrode (i.e., the first terminal of Cp) in common.

The reset rising pulse supply circuit 430 and the reset falling pulse supply circuit 440 are the driving circuits for applying the reset pulse to the Y electrode (i.e., the first terminal of Cp) during the reset period. The reset rising pulse supply circuit 430 includes a power source (not shown) and a switch (not shown) for applying a second voltage to increase a voltage of the Y electrode from the first voltage gradually during the reset rising period. On the contrary, the reset falling pulse supply circuit 440 includes a power source (not shown) and a switch (not shown) for providing a third voltage by decreasing the voltage of the Y electrode from the first voltage gradually during the reset falling period.

The scan low pulse supply circuit 450 and the scan high pulse supply circuit 460 are the driving circuits for applying a scan pulse to the Y electrode (i.e., the first terminal of Cp) during an address period. The scan low pulse supply circuit 450 generates address discharges for selected discharge cells by applying a scan low pulse having a fourth voltage to the Y electrode (i.e., the first terminal of Cp). The scan low pulse supply circuit 450 includes a power source (not shown) and a switch (not shown) for applying the fourth voltage. The fourth voltage is set to a value that is the same as or somewhat lower than the third voltage of the reset falling pulse. Therefore, the scan low pulse supply circuit 450 can share a same power source with the reset falling pulse supply circuit 440. The scan high pulse supply circuit 460 enables discharging of selected discharge cells by applying a fifth voltage to the Y electrode (i.e., the first terminal of Cp). The scan high pulse supply circuit 460 includes a power source (not shown) and a scanning capacitor (not shown) for applying the fifth voltage.

The scanning switch circuit 470 includes a first scanning switch SC1 and a second scanning switch SC2 for selecting the scan pulse to be applied to the Y electrode (i.e., the first terminal of Cp) during the address period. At a node P3, the first scanning switch SC1 and the second scanning switch SC2 are coupled together to the Y electrode, (i.e., the first terminal of Cp). The first scanning switch SC1 is coupled to the scan high pulse supply circuit 460 to enable a scan high pulse to be applied to the Y electrode (i.e., the first terminal of Cp). The second scanning switch SC2 is coupled to the scan low pulse supply circuit 450 to enable a scan low pulse to be applied to the Y electrode (i.e., the first terminal of Cp).

The second scanning switch SC2 operates when the sustain pulses are applied to the Y electrode during the sustain period. The second scanning switch SC2 is coupled between the panel capacitor Cp and the first resonance coil L1. Therefore, all current paths for applying the sustain pulses to the Y electrode (i.e., the first terminal of Cp) during the sustain period pass through the second scanning switch SC2.

The respective power sources included in the reset falling pulse supply circuit 440 and the scan low pulse supply circuit 450 of the first electrode driver 400 provide a voltage lower than the ground voltage for applying a waveform of a negative polarity to the Y electrode. Therefore, a short current can flow between the power source of the reset falling pulse supply circuit 440 and the ground GND of the first sustain pulse driving circuit 420. For preventing such short current, the first electrode driver 400 includes a short prevention switch Ypn coupled between the reset falling pulse supply circuit 440 and the first sustain pulse driving circuit 420.

The short prevention switch Ypn is also coupled between the panel capacitor Cp and the first resonance coil L1. All current paths for applying the sustain pulses to the Y electrode (i.e., the first terminal of Cp) during the sustain period pass through the short prevention switch Ypn.

The second electrode driver 500 includes a second energy recovery circuit 510, a second sustain pulse driving circuit 520, and a bias voltage supply circuit 530.

The second energy recovery circuit 510 includes a second supply switch Xr, a second recovery switch Xf, a second energy charging/discharging capacitor C2 and a second resonance coil L2. A first terminal of the second resonance coil L2 is coupled to the X electrode (i.e., the second terminal of Cp), and a second terminal thereof is coupled to a node P4 at which a source terminal of the second supply switch Xr and a drain terminal of the second recovery switch Xf are coupled to each other. The second energy charging/discharging capacitor C2 is coupled between ground GND and a node P5 at which a drain terminal of the second supply switch Xr and a source terminal of the second recovery switch Xf are coupled to each other. The second energy recovery circuit 510 can further include a third diode D3 having an anode coupled to the second supply switch Xr and a cathode coupled to the second resonance coil L2, and a fourth diode D4 having an anode coupled to the second resonance coil L2 and a cathode coupled to the second recovery switch Xf.

The second resonance coil L2 supplies or recovers the energy to or from the panel capacitor Cp by the LC resonance generated by using the second resonance coil L2 and the panel capacitor Cp. An inductance of the second resonance coil L2 necessary for the LC resonance is suitably selected based on the capacitance of the panel capacitor Cp. In one embodiment, the inductance of the first resonance coil L2 is selected based on the parasitic inductance, the parasitic capacitance, and the parasitic resistance of the corresponding LC resonance circuit path.

The second sustain pulse driving circuit 520 applies the sustain pulses to the X electrode (i.e., the second terminal of Cp) during the sustain period. The second sustain pulse driving circuit 520 includes an X electrode first voltage driving circuit 521 and an X electrode ground voltage driving circuit 522. The X electrode first voltage driving circuit 521 is coupled to the first power source Vs for applying the first voltage to the X electrode. The X electrode first voltage driving circuit 521 includes an X electrode first voltage switch Xs having a first terminal coupled to the first power source Vs and a second terminal coupled to the X electrode (i.e., the second terminal of Cp). The X electrode ground voltage driving circuit 522 is coupled to ground GND and includes an X electrode ground voltage switch Xg having a first terminal coupled to ground GND and a second terminal coupled to the X electrode (i.e., the second terminal of Cp). The second terminal of the X electrode first voltage switch Xs and the second terminal of the X electrode ground voltage switch Xg are coupled to the X electrode (i.e., the second terminal of Cp).

The bias voltage supply circuit 530 applies a bias voltage pulse to the X electrode (i.e., the second terminal of Cp) during the reset falling period and the address period. The bias voltage supply circuit 530 includes a power source (not shown) for applying the bias voltage pulse and a switch (not shown).

The above-mentioned plasma display device has a complicated structure in which the first electrode driver 400 has relatively more power sources and switches as compared with those of the second electrode driver 500.

The first electrode driver 400 includes the short prevention switch Ypn and the second scanning switch SC2 coupled between the first resonance coil L1 and the panel capacitor Cp. In one embodiment, the exemplary switching elements of the present invention can be a type of Metal Oxide Semiconductor Field Effect Transistor (MOSFET); therefore, a parasitic capacitor exists between the source terminal and the drain terminal of the exemplary switching element. The parasitic capacitor contributes to the capacitance of the panel capacitor Cp when the LC resonance is generated by operating the first resonance coil L1 and the panel capacitor Cp together. Since the switching element also has a parasitic resistance which increases an impedance of the first electrode driver 400, efficiency of the LC resonance is decreased.

In a current path for applying a maintaining voltage, the current path through the first electrode driver 400, including the short prevention switch Ypn and the second scanning switch SC2, is longer than that through the second electrode driver 500. Therefore, a parasitic inductance of the current path through the first electrode driver 400 is larger than that through the second electrode driver 500.

The first electrode driver 400 and the second electrode driver 500 have different respective parasitic components (e.g., parasitic capacitance, parasitic resistance, and the parasitic inductance). For compensating these differences, the inductance of the first resonance coil L1 is set to a value different from that of the second resonance coil L2. In one embodiment, the first resonance coil L1 has an inductance smaller than that of the second resonance coil L2. Since the parasitic capacitance of the first electrode driver 400 is smaller than the parasitic capacitance of the second electrode driver 500, the parasitic resistance and the parasitic impedance components of the first electrode driver 400 have larger values than those of the second electrode driver 500 during the sustain period. Therefore, the inductance of the first resonance coil L1 is set to a value smaller than that of the second resonance coil L2 to compensate the effect due to the differences between the respective parasitic components of the first electrode driver 400 and the second electrode driver 500.

The respective inductances of the first resonance coil L1 and the second resonance coil L2 are selected based on the respective parasitic components of the first electrode driver 400 and the second electrode driver 500, and the frequency characteristics of the plasma display device. When the respective inductances of the first resonance coil L1 and the second resonance coil L2 are large, the LC resonance efficiency becomes lower. When the respective inductances are small, respective consumption efficiencies of the first energy recovery circuit 410 and the second energy recovery circuit 510 are lower. Therefore, a suitable inductance should be selected taking in consideration of the effect of the inductance on circuit performance. According to one embodiment of the present invention, the inductance of the first resonance coil L1 can be set to a value substantially between 0.1 μH and 0.2 μH, and the inductance of the second resonance coil L2 can be set to a value substantially between 0.2 μH and 0.3 μH. After taking the parasitic components into account, the inductance of the first resonance coil L1 is set a value smaller than that of the second resonance coil L2. In one embodiment, the inductance of the first resonance coil L1 is set to be 0.15 μH, and the inductance of the second resonance coil L2 is set to be 0.25 μH.

Furthermore, the respective driving circuits included in the first electrode driver 400 and the second electrode driver 500 can operate differently depending on the shapes of the respective driving pulses applied to the Y electrode (i.e., the first terminal of Cp) and the X electrode (i.e., the second terminal of Cp). Also, current paths through the first electrode driver 400 and the second electrode driver 500 can be formed for applying the respective driving pulses to the Y electrode (i.e., the first terminal of Cp) and the X electrode (i.e., the second terminal of Cp). In addition, respective states of the switching elements of the driving circuits can change corresponding to the various current paths. Therefore, the respective inductances of the first resonance coil L1 and the second resonance coil L2 are set to suitable values according to the various layout of the driving circuits and the circuit elements, and the present invention is not limited to them.

The panel capacitor Cp in the exemplary embodiment is illustrated as a capacitor representing the capacitive component disposed at a crossing between the Y electrode and the X electrode.

According to an exemplary embodiment of the present invention, the steps for applying the sustain pulses in a time sequence during the sustain period will be explained.

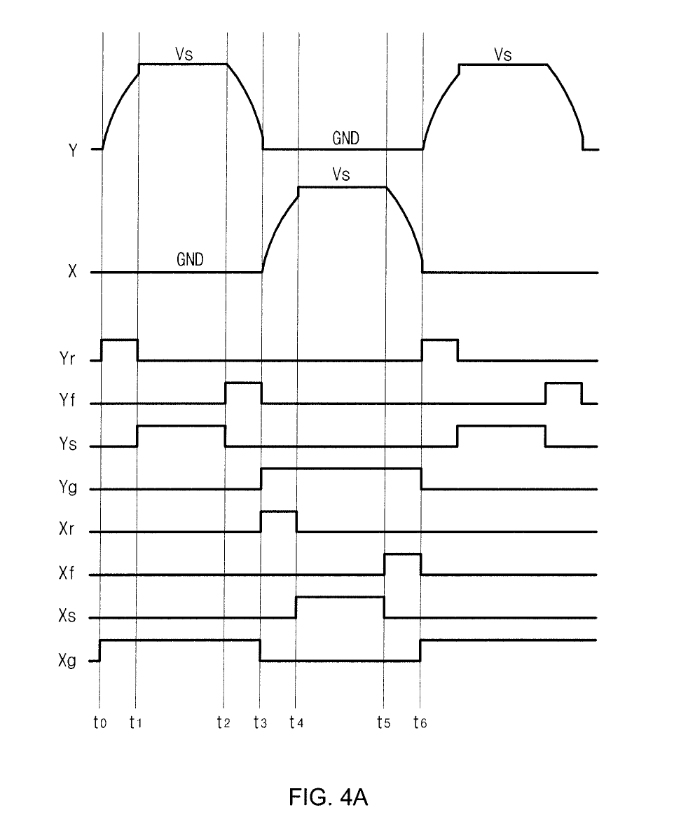

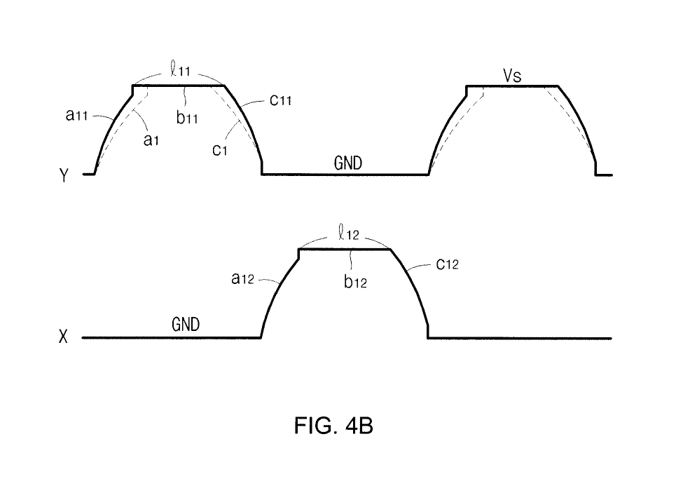

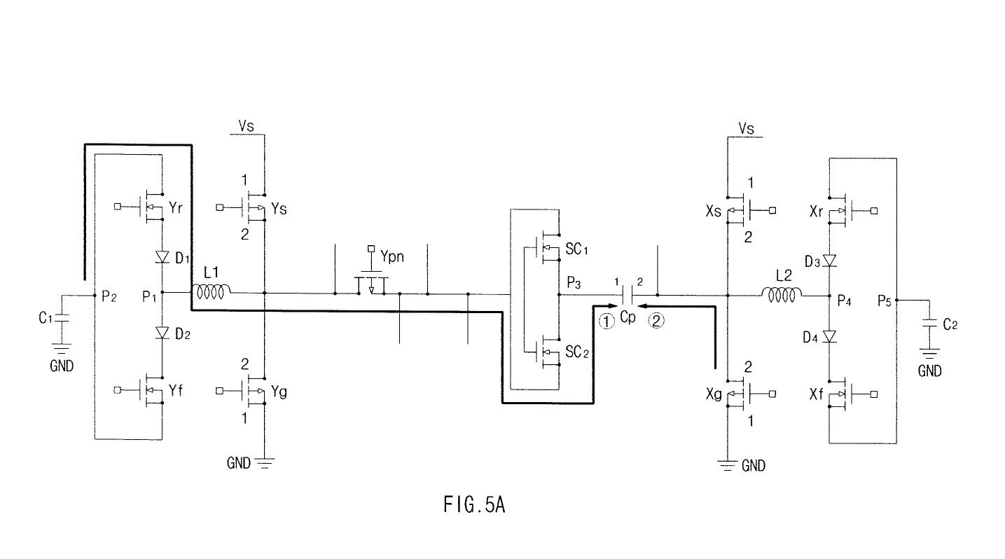

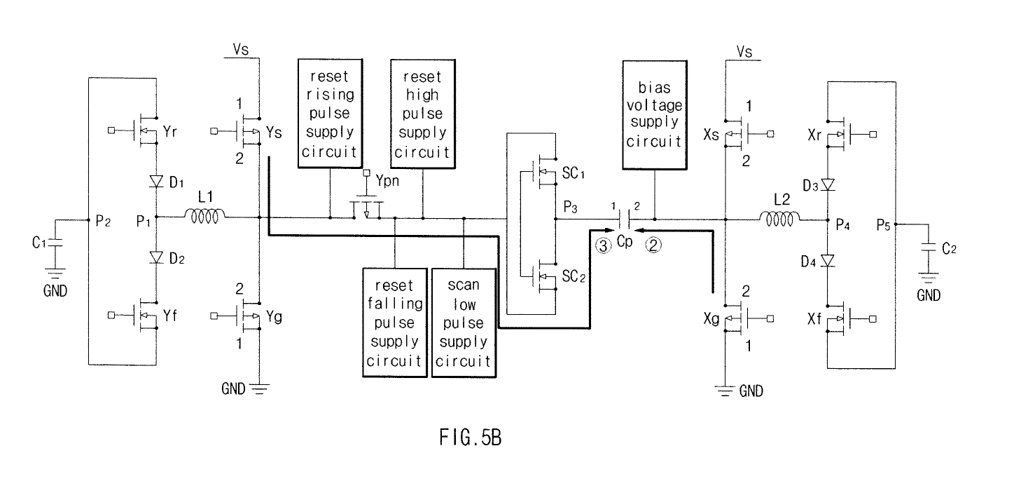

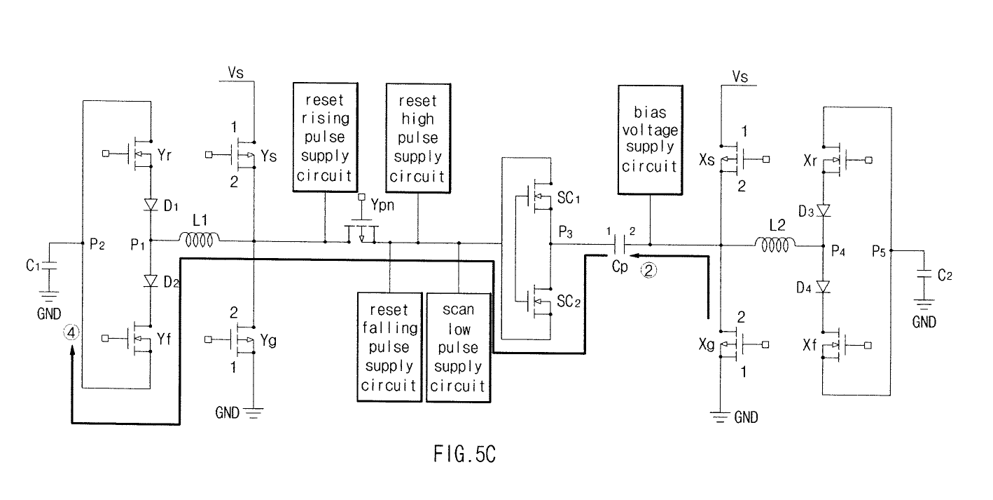

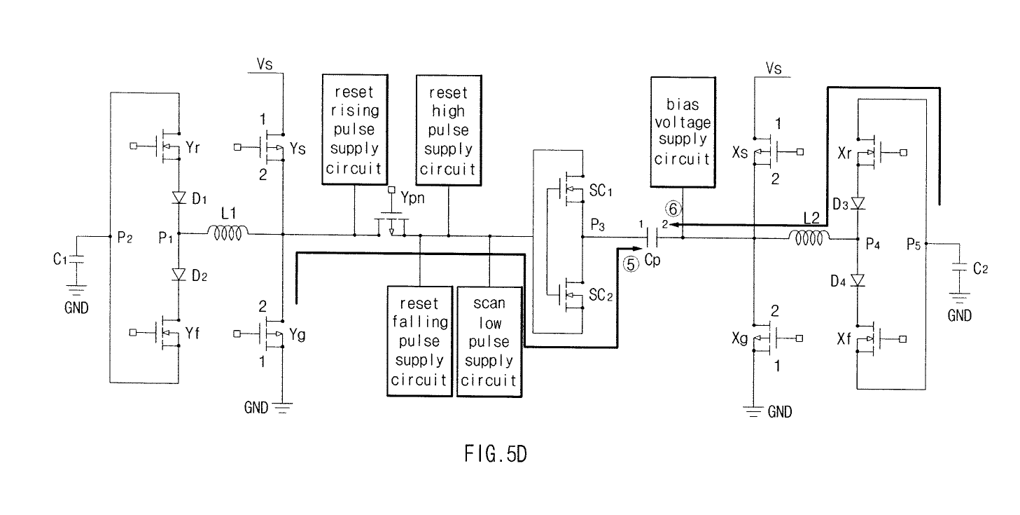

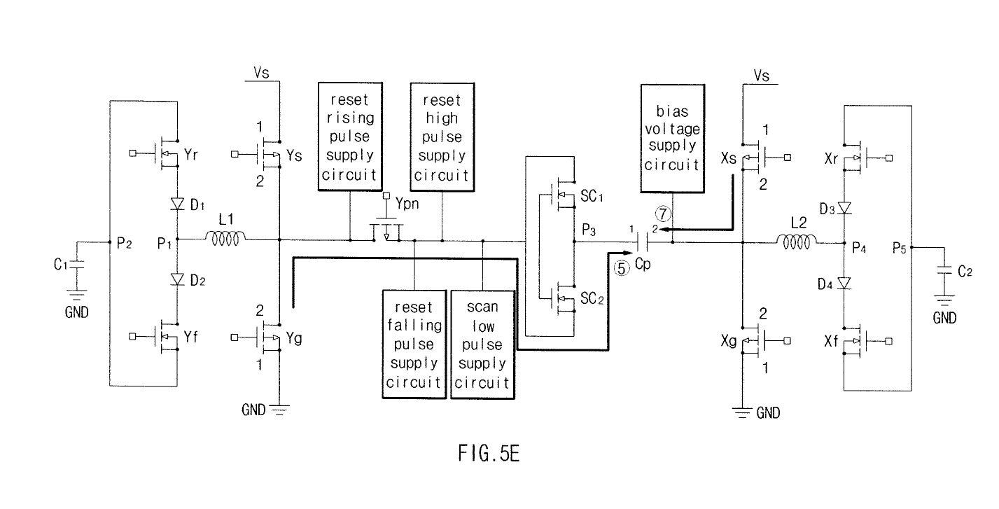

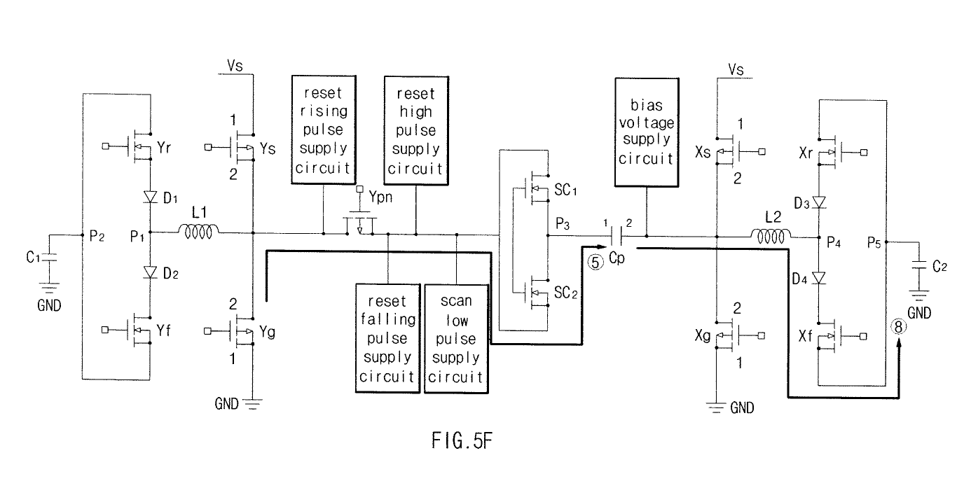

FIG. 4a illustrates a timing diagram of the sustain pulses of the plasma display device illustrated in FIG. 3, and FIG. 4b illustrates an enlarged diagram of the sustain pulses of FIG. 4a. FIGS. 5a-5f illustrate the current paths corresponding to each of the steps of the timing diagram illustrated in FIG. 4a.

Referring to FIGS. 4a-5f, in one embodiment, the steps for generating the sustain pulses by the driving circuits of the plasma display device include a first step (t0-t1) in which a voltage of the Y electrode (i.e., the first terminal of Cp) rises to a first voltage; a second step (t1-t2) in which the voltage of the Y electrode is maintained at the first voltage; a third step (t2-t3) in which the voltage of the Y electrode falls from the first voltage to a ground voltage while a voltage of the X electrode (i.e., the second terminal of Cp) is maintained at the ground voltage during the first, second, and third steps; a fourth step (t3-t4) in which the voltage of the X electrode (i.e., the second terminal of Cp) rises from the ground voltage to the first voltage; a fifth step (t4-t5) in which the voltage of the X electrode is maintained at the first voltage; and a sixth step (t5-t6) in which the voltage of the X electrode falls from the first voltage to the ground voltage while the Y electrode (i.e., the first terminal of Cp) is maintained at the ground voltage during the fourth, fifth, and sixth steps. The changes of the voltages of each of the steps are the result of operating the switches of the driving circuits. The sustain pulses illustrated by the six steps of FIG. 4a are not a continuous oscillation, but are the results of changing the respective voltages and currents of the X electrode and the Y electrode by controlling the openings and closings of the switches Yr, Yf, Xr, and Xf in combination with the resonance coils L1, L2, and the panel capacitor Cp.

In the exemplary embodiment, it is assumed that the ground voltage is applied to the Y electrode (i.e., the first terminal of Cp) and the X electrode (i.e., the second terminal of Cp) before the first step (t0-t1) is executed.

In FIG. 4a, during the time from the first step (t0-t1) through the third step (t2-t3), the X electrode ground voltage switch Xg is closed for providing the ground voltage, and the second electrode driver 500 maintains a second current path (\textcircled{2}) including ground GND, the X electrode ground voltage switch Xg, and the X electrode (i.e., the second terminal of Cp).

During the first step (t0-t1), the first supply switch Yr, the short prevention switch Ypn, and the second scanning switch SC2 of the first electrode driver 400 are closed. As a result, a first current path (\textcircled{1}) including the first energy charging/discharging capacitor C1, the first supply switch Yr, the first diode D1, the first resonance coil L1, the short prevention switch Ypn, the second scanning switch SC2, and the Y electrode (i.e., the first terminal of Cp) is formed. The LC resonance is generated between the first resonance coil L1 and the panel capacitor Cp due to the formation of the first current path (\textcircled{1}), and while the energy stored in the first energy charging/discharging capacitor C1 is transferred to the panel capacitor Cp, the voltage of the Y electrode (i.e., the first terminal of Cp) rises to a voltage in the vicinity of the first voltage. The impedance of the first resonance coil L1 is set to a suitable value for compensating reduction of the LC resonance efficiency caused by the parasitic inductance, the parasitic capacitance, and the parasitic resistance of the current path (\textcircled{1}) and the switching elements Yr, Ypn, and SC2. If the LC resonance efficiency increases, the voltage of the Y electrode rises more rapidly, thereby the discharge start timing is shortened.

During the second step (t1-t2), the Y electrode first voltage switch Ys, the short prevention switch Ypn, and the second scanning switch SC2 of the first electrode driver 400 are closed. As a result, a third current path (\textcircled{3}) including the first power source Vs, the Y electrode first voltage switch Ys, the short prevention switch Ypn, the second scanning switch SC2, and the Y electrode (i.e., the first terminal of Cp) is formed. The voltage of the Y electrode rises to a first voltage due to the formation of the third current path (\textcircled{3}) and maintains at the first voltage during the second step.

During the third step (t2-t3), the first recovery switch Yf, the short prevention switch Ypn, and the second scanning switch SC2 are closed. As a result, a fourth current path (\textcircled{4}) including the Y electrode (i.e., the first terminal of Cp), the second scanning switch SC2, the short prevention switch Ypn, the first resonance coil L1, the second diode D2, the first recovery switch Yf, and the first energy charging/discharging capacitor C1 is formed. The LC resonance is generated between the first resonance coil L1 and the panel capacitor Cp due to the formation of the fourth current path (\textcircled{4}), and while the energy charged in the panel capacitor Cp is recovered to the first energy charging/discharging capacitor C1 once again, the voltage of the Y electrode falls to a voltage in the vicinity of the ground voltage. The falling time of the voltage of the Y electrode is determined by the LC resonance efficiency, and as the LC resonance efficiency increases, the voltage falls more rapidly.

The first ground voltage switch Yg, the short prevention switch Ypn, and the second scanning switch SC2 are closed to provide the ground voltage to the Y electrode (i.e., the first terminal of Cp) during the time interval from the fourth step (t3-t4) through the sixth step (t5-t6) to create a fifth current path (\textcircled{5}) including ground GND, the first ground voltage switch Yg, the short prevention switch Ypn, the second scanning switch SC2, and the Y electrode (the first terminal of Cp).

During the fourth step (t3-t4), the second supply switch Xr of the second electrode driver 500 is closed. Therefore, a sixth current path (\textcircled{6}) including the second energy charging/discharging capacitor C2, the second supply switch Xr, the third diode D3, the second resonance coil L2, and the X electrode (the second terminal of Cp) is formed. The LC resonance is generated between the second resonance coil L2 and the panel capacitor Cp due to the formation of the sixth current path (\textcircled{6}), and while the energy stored in the second energy charging/discharging capacitor C2 is transferred to the panel capacitor Cp, the voltage of the X electrode (i.e., the second terminal of Cp) rises to a voltage in the vicinity of the first voltage. Although the sixth current path (\textcircled{6}) is a shorter current path than the first current path (\textcircled{1}) and includes fewer circuit elements than that of the first current path (\textcircled{1}) in the first step (t0-t1), the respective rise times of the sustain pulses of the X electrode and the Y electrode are substantially identical. It is because the inductance of the first resonance coil L1 is set to a suitable value smaller than that of the second resonance coil L2, and thereby the first electrode driver 400 and the second electrode driver 500 have substantially the same resonance efficiency when the sustain pulses are applied to the Y electrode (i.e., the first terminal of Cp) and the X electrode (i.e., the second terminal of Cp).

During the fifth step (t4-t5), the X electrode first voltage switch Xs is closed. As a result, a seventh current path (\textcircled{7}) including the first power source Vs, the X electrode first voltage switch Xs, and the X electrode (i.e., the second terminal of Cp) is formed. The voltage of the X electrode rises to the first voltage due to formation of the seventh current path (\textcircled{7}) and maintains at the first voltage during the fifth step.

During the sixth step (t5-t6), the second recovery switch Xf is closed. As a result, an eighth current path (\textcircled{8}) including the X electrode (i.e., the second terminal of Cp), the second resonance coil L2, the fourth diode D4, the second recovery switch Xf, and the second energy charging/discharging capacitor C2 is formed. The LC resonance is generated between the second resonance coil L2 and the panel capacitor Cp due to the formation of the eighth current path (\textcircled{8}), and while the energy charged in the panel capacitor Cp is recovered to the second energy charging/discharging capacitor C2 once again, the voltage of the X electrode falls to a voltage in the vicinity of the ground voltage.

The above-described step sequence is executed in a sub-field for a number of times corresponding to a weight value of the sub-field. Thus, the sustain pulses having the first voltage and the ground voltage are alternately applied to the Y electrode (i.e., the first terminal of Cp) and the X electrode (i.e., the second terminal of Cp).

Referring to FIG. 4b, the sustain pulse applied to the Y electrode has a voltage rising edge a11 and a voltage falling edge c11, and both edges a11 and c11 are relatively faster as compared with a conventional voltage rising edge a1 and a conventional voltage falling edge c1 as indicated by the broken lines. It is because the inductance of the first resonance coil L1 is selected to be a suitable value for compensating the parasitic components of the current paths and the parasitic components of the switching elements for applying the sustain pulse to the Y electrode (i.e., the first terminal of Cp), and thus, the rising edge and the falling edge of the sustain pulse applied to the Y electrode have faster edges. In comparison to the second resonance coil L2, the first resonance coil L1 is set to an adequately small inductance such that the sustain pulse applied to the Y electrode and the sustain pulse applied to the X electrode (i.e., the second terminal of Cp) are relatively identical. Therefore, the respective slops of the voltage rising edges a11, a12 and the voltage falling edges c11, c12 are relatively identically. Also, a maintaining period b11 of the sustain pulse applied to the Y electrode and a maintaining period b12 of the sustain pulse applied to the X electrode are substantially identical (i.e., I₁₁≈I₁₂).

The sustain pulse applied to the Y electrode of FIG. 4b improves the discharging smear by effectively reducing the time difference between a discharge start timing of the sustain pulse applied to the Y electrode and a discharge start timing of the sustain pulse applied to the X electrode. Furthermore, since a voltage rising time and a voltage falling time of the sustain pulse applied to the Y electrode are shortened, respective heat dissipations of the switching elements (i.e., Yr and Ys) for applying the sustain pulse to the Y electrode are reduced.

The present invention is not limited to the above-mentioned exemplary embodiments, and it is noted that various modifications can be realized by a person skilled in the art without deviating from the scope and spirit of the present invention. The scope of the present invention is defined by the appended claims and their equivalents.

As described above, the first resonance coil L1 and the second resonance coil L2, included in the first electrode driver 400 and the second electrode driver 500 respectively, are set to different inductances in order to reduce the discharging smear of the plasma display device during the sustain period.

According to the embodiments of the present invention, since the voltage rising time and the voltage falling time of the sustain pulse applied to the Y electrode are shortened, the heat dissipations of the switching elements operated for applying the sustain pulse can be reduced. While the embodiments of the present invention are described primarily in reference to a single panel capacitor Cp formed between a single X electrode and a single Y electrode, the PDP in practice includes multiple panel capacitors (Cp), each formed between adjacent X and Y electrodes.

What is clamed is:

1. A plasma display device comprising:
a plasma display panel having a plurality of first electrodes and a plurality of second electrodes;
a first electrode driver for driving the plurality of first electrodes, the first electrode driver comprising a first energy recovery circuit having a first resonance coil; and
a second electrode driver for driving the plurality of second electrodes, the second electrode driver comprising a second energy recovery circuit having a second resonance coil, the first resonance coil having a first inductance that is different from a second inductance of the second resonance coil.

2. The plasma display device as claimed in claim 1,
wherein the first electrode driver and the second electrode driver each comprise a sustain pulse driving circuit, and
the sustain pulse driving circuit comprises a first voltage supply circuit for applying a first voltage to the first electrodes or the second electrodes and a ground voltage supply circuit for applying ground to the first electrodes or the second electrodes.

3. The plasma display device as claimed in claim 2,
wherein the first voltage supply circuit comprises a first voltage switch having a first voltage terminal coupled to a first power supply,
the ground voltage supply circuit comprises a ground voltage switch having a first ground terminal coupled to ground, and
a second voltage terminal of the first voltage switch and a second ground terminal of the ground voltage switch are coupled to the first electrodes or the second electrodes, respectively.

4. The plasma display device as claimed in claim 2, wherein the first electrode driver further comprises:
a reset rising pulse supply circuit for applying a second voltage to the first electrodes by increasing a voltage applied to the first electrodes from the first voltage gradually during a reset rising period;
a reset falling pulse supply circuit for applying a third voltage to the first electrodes by reducing the voltage applied to the first electrodes from the first voltage gradually during a reset falling period;
a scanning switch circuit including a first scanning switch and a second scanning switch, the first scanning switch and the second scanning switch coupled to the first electrodes; and
a scan low pulse supply circuit and a scan high pulse supply circuit for applying a fourth voltage and a fifth voltage, respectively, to the first electrodes in response to operations of the scanning switch circuit during an address period.

5. The plasma display device as claimed in claim 4, wherein the first electrode driver further comprises:
a short prevention switch coupled between the sustain pulse driving circuit and the reset falling pulse supply circuit.

6. The plasma display device as claimed in claim 1, wherein the second electrode driver further comprises a bias voltage supply circuit for applying a bias voltage higher than an address voltage to the second electrodes during the reset falling period and the address period.

7. The plasma display device as claimed in claim 5, wherein the short prevention switch and the second scanning switch are coupled between the first resonance coil and a panel capacitor formed between a corresponding one of the first electrodes and a corresponding one of the second electrodes.

8. The plasma display device as claimed in claim 5, wherein the short prevention switch and the second scanning switch are Metal Oxide Semiconductor Field Effect Transistor (MOSFET) type switches.

9. The plasma display device as claimed in claim 1, wherein a first current path of the first electrode driver for applying a first sustain pulse to the first electrodes is longer than a second current path of the second electrode driver for applying a second sustain pulse to the second electrodes.

10. The plasma display device as claimed in claim 1, wherein the first inductance of the first resonance coil is smaller than the second inductance of the second resonance coil.

11. The plasma display device as claimed in claim 1, wherein the first inductance of the first resonance coil is substantially between 0.1 μH and 0.2 μH, and the second inductance of the second resonance coil is substantially between 0.2 μH and 0.3 μH.

12. The plasma display device as claimed in claim 1,
wherein the first energy recovery circuit and the second energy recovery circuit further comprise a first supplying switch and a first recovery switch, and a second supplying switch and a second recovery switch, respectively, for supplying and recovering energy to and from the plasma display panel, and
a first terminal of the first resonance coil and a first terminal of the second resonance coil are coupled to the first electrodes and the second electrodes, respectively, a second terminal of the first resonance coil is coupled to a source terminal of the first supplying switch and a drain terminal of the first recovery switch, and a second terminal of the second resonance coil is coupled to a source terminal of the second supplying switch and a drain terminal of the second recovery switch.

13. The plasma display device as claimed in claim 12,
wherein the first energy recovery circuit and the second energy recovery circuit comprise a first energy charging/discharging capacitor and a second energy charging/discharging capacitor, respectively,
the first energy charging/discharging capacitor is coupled between ground and a first node that is coupled to a drain terminal of the first supplying switch and a source terminal of the first recovery switch, and
the second energy charging/discharging capacitor is coupled between ground and a second node that is coupled to a drain terminal of the second supplying switch and a source terminal of the second recovery switch.

14. A plasma display device comprising:
a plasma display panel having a plurality of first electrodes and a plurality of second electrodes;
a first electrode driver for applying a first sustain pulse to the plurality of first electrodes; and
a second electrode driver for applying a second sustain pulse to the plurality of second electrodes, the first sustain pulse and the second sustain pulse are alternately applied,
wherein the first electrode driver and the second electrode driver are configured to generate the first and the second sustain pulses that have at least one of substantially same rising slopes or substantially same falling slopes.

15. The plasma display device as claimed in claim 14,
wherein the first electrode driver comprises a first energy recovery circuit having a first resonance coil, and
the second electrode driver comprises a second energy recovery circuit having a second resonance coil, the first resonance coil having a first inductance that is difference from a second inductance of the second coil.

16. The plasma display device as claimed in claim 14,
wherein the first electrode driver applies the first sustain pulse through a first current path, and
the second electrode driver applies the second sustain pulse through a second current path, the first current path being longer than the second current path.
